(19) United States
(12) Patent Application Publication
(10) Pub. No.: US 2025/0211064 A1
(43) Pub. Date: Jun. 26, 2025

(54) Cooling-Fluid-Conducting Rotor Shaft for a Rotor of an Electrical Machine, Having a Two-Part Inflow Region

(71) Applicant: Bayerische Motoren Werke Aktiengesellschaft, Muenchen (DE)

(72) Inventor: Rafael SABAINI, Steyr (AT)

(21) Appl. No.: 18/847,562

(22) PCT Filed: May 22, 2023
(86) PCT No.: PCT/EP2023/063637

§ 371 Date: Sep. 16, 2024

(30) Foreign Application Priority Data
Jun. 14, 2022 (DE) 10 2022 114 906.4

(51) Int. Cl. H02K 9/197; H02K 7/00

(52) U.S. Cl. CPC H02K 9/197; H02K 7/003

(57) ABSTRACT

A rotor shaft includes a hollow shaft for conducting a cooling fluid in a cavity enclosed by a shaft outer wall, wherein the outer wall has a first radial outlet opening in a first end portion and a second radial outlet opening in an axially opposite second end portion for letting fluid out into a surrounding environment. An inflow region is arranged in the region of the first end portion and is subdivided into at least two chambers by an axially extending partition wall for splitting the fluid into two parallel cooling fluid flows. A first chamber is fluidically coupled to the first outlet opening, and a second chamber is designed without a bottom to pass the second cooling fluid flow into the cavity and is fluidically coupled to the second outlet opening to allow the second cooling fluid flow out radially at the second side.

### BACKGROUND AND SUMMARY

The invention relates to a rotor shaft for a rotor of an electric machine. The rotor shaft has a tubular hollow shaft for supporting a rotor core of the rotor and for conducting a cooling fluid in a cavity which is enclosed by an outer wall of the hollow shaft, wherein the outer wall has, in order to discharge the cooling fluid on two axially opposite sides of the rotor shaft into a surrounding area, at least one first radial outlet opening in a first end portion of the outer wall and at least one second radial outlet opening in an axially opposite second end portion of the outer wall. Moreover, the rotor shaft has an inflow region for the cooling fluid which is arranged in the region of the first end portion in the cavity. The invention relates, moreover, to a rotor for an electric machine, and to an electric machine.

In the present case, interest focuses on electric machines which can be used, for example, as drive units for electrified motor vehicles, that is to say electric or hybrid vehicles. Electric units of this type usually have a stator and a rotor which is mounted rotatably with regard to the stator. The rotor has a rotor core, for example a laminated core, through which a rotor shaft is guided and is connected fixedly to the rotor for conjoint rotation. Moreover, the rotor core supports a magnetic field-generating component of the rotor, for example permanent magnets, energizable rotor windings and/or short circuit rods. In order to cool the rotor, it is known from the prior art for the rotor shaft to be configured as a hollow shaft and for a cooling fluid, for example an oil, to flow through said hollow shaft.

The cooling fluid is usually introduced into the hollow shaft axially on a first side of the hollow shaft, for example an output side or transmission side, and leaves the hollow shaft via outlet openings, for example bores on the first side and on a second side which lies axially opposite the first side, in order to deposit it onto stator winding heads of the stator, for example for cooling purposes. An adjustment of the cooling fluid quantity between the first side and the second side usually does not take place in a manner which is independent of the rotational speed, since the introduced cooling fluid quantity has an axial component which is independent of the rotational speed and a radial component which is dependent on the rotational speed.

It is an object of the present invention to provide a simple solution for cooling an electric machine in a manner which is independent of the rotational speed.

According to the invention, this object is achieved by a rotor shaft, a rotor and an electric machine with the features according to the present disclosure. Advantageous embodiments of the invention are also the subject matter of the description and the figures.

A rotor shaft according to the invention for a rotor of an electric machine has a tubular hollow shaft for supporting a rotor core of the rotor and for conducting a cooling fluid in a cavity which is enclosed by an outer wall of the hollow shaft. The outer wall has, in order to discharge the cooling fluid on two axially opposite sides of the rotor shaft into a surrounding area, at least one first radial outlet opening in a first end portion of the outer wall and at least one second radial outlet opening in an axially opposite second end portion of the outer wall. Moreover, the rotor shaft has an inflow region for the cooling fluid which is arranged in the region of the first end portion in the hollow shaft. The inflow region is divided by at least one axially extending dividing wall into at least two chambers for splitting the cooling fluid into at least two parallel cooling fluid flows. A first chamber is closed axially by a bottom wall which forms an axial baffle wall for the first cooling fluid flow and is coupled fluidically to the at least one first outlet opening for the radial discharge of the first cooling fluid flow on the first side of the rotor shaft. A second chamber is configured without a bottom in order to introduce the second cooling fluid flow into the cavity axially and is coupled fluidically to the at least one second outlet opening for the radial discharge of the second cooling fluid flow on the second side of the rotor shaft.

The invention also relates to a rotor for an electric machine comprising a rotor core, a magnetic field-generating component which is held by the rotor core, and a rotor shaft according to the invention. An electric machine according to the invention for a motor vehicle comprises a stator and a rotor according to the invention which is mounted rotatably with regard to the stator. The stator has a stator core with energizable stator windings. The electric machine can be a permanently excited electric machine, in the case of which the magnetic field-generating component of the rotor has permanent magnets, or it can be a separately excited electric machine, in the case of which the magnetic field-generating component of the rotor has energizable windings. The rotor core of the rotor can be configured, for example, as a laminated core consisting of axially stacked sheet metal laminations, and can have an axial leadthrough for the rotor shaft which is connected fixedly to the rotor core for conjoint rotation.

The rotor shaft has the tubular, hollow-cylindrical hollow shaft which extends in the axial longitudinal direction. The outer wall of the hollow shaft has an outer side, facing the rotor core, and an inner side, facing the cavity. The hollow shaft is of open configuration on a first side of the axial sides, in particular on a transmission side, via which the rotor shaft can be coupled for the transmission of torque to a transmission shaft of a transmission of the motor vehicle. The inflow region for the cooling fluid into the hollow shaft is also situated on this first side. For example, the hollow shaft can be tapered in the region of the first end portion, wherein the inflow region extends only over the tapered region of the hollow shaft. The cooling fluid can be, for example, oil. The second side which lies axially opposite the first side can, for example, be covered on the end side and can therefore be closed. The first end portion of the outer wall is situated on the first side, and the second end portion of the outer wall is situated on the second side. The end portions of the outer wall have the respective radial outlet openings for radially discharging or depositing the cooling fluid on both sides into a surrounding area of the rotor. Via the radial outlet openings, the cooling fluid can be deposited on the two opposite sides of the rotor shaft, for example, onto winding heads of the stator which are situated there and are formed by the stator windings on axially opposite end sides of the stator core. In this way, both the rotor core can be cooled by the axial throughflow of the hollow shaft and the stator can be cooled by depositing of the cooling fluid.

In order for it to be possible for the cooling fluid to be split, in particular in a manner which is independent of the rotational speed, to the two axially opposite sides or ends of the rotor shaft, the inflow region has at least two chambers which are configured transversely with respect to the longitudinal direction and so as to adjoin one another in the circumferential direction and are separated from one another by the dividing wall. During the inflow of the cooling fluid into the inflow region, the cooling fluid is split into at least two parallel cooling fluid flows, wherein the first cooling fluid flow flows into the first chamber and the second cooling fluid flow flows into the second chamber. The inflow region is therefore configured as a cooling fluid splitter, in particular as an oil splitter. A splitting ratio of the cooling fluid to the two chambers can be set here via a position of the dividing wall. In particular, the dividing wall is arranged centrally in the inflow region, with the result that the two chambers are configured with an identical size and each configure half of the inflow region. In this way, the cooling fluid is split, in particular, in such a way that each cooling fluid flow conducts approximately the same quantity of cooling fluid. The cooling fluid volume can also, however, be intentionally split non-uniformly via the area ratio of the two chambers, for example 80% of the fluid volume in one chamber and 20% of the fluid volume in the other chamber.

The first chamber is designed to feed the cooling fluid of the first cooling fluid flow to the at least one first outlet opening. To this end, the first chamber and the at least one first outlet opening are coupled fluidically to one another. The first chamber is designed to prevent the cooling fluid from flowing out of the first chamber into the hollow shaft and therefore flowing away from the first end portion in the direction of the second end portion. For this purpose, the first chamber has the bottom wall, on which the cooling fluid of the first cooling fluid flow bounces back axially and therefore remains in the first chamber and therefore in the region of the first end portion. That cooling fluid of the first cooling fluid flow which is deflected in the radial direction by the baffle wall exits the first chamber via the at least one first radial outlet opening on the first side of the rotor shaft into the surrounding area.

The second chamber is designed to feed the cooling fluid of the second cooling fluid flow to the at least one second outlet opening. To this end, the second chamber and the at least one second outlet opening are coupled fluidically to one another. For this purpose, the second chamber does not have a bottom wall, but rather is of open configuration in the direction of the cavity. As a result, the second cooling fluid flow flows through the second chamber and the cavity axially, and exits on the second side by the at least one second outlet opening radially into the surrounding area. Here, in particular, the chambers are coupled only to the at least one associated outlet opening, with the result that the splitting of the cooling fluid to the two sides of the rotor shaft can be set exactly.

It can be provided that the inflow region has a side wall which runs around in the circumferential direction, is connected to the dividing wall, is arranged so as to bear against an inner side of the outer wall, and has at least one radial through opening for the first cooling fluid flow in the region of the first chamber. The at least one radial through opening is arranged aligned with respect to the at least one first outlet opening. The inflow region is configured, in particular, as a separate component which is plugged into the hollow shaft and is connected mechanically to the hollow shaft. Here, the outer wall in the region of the first end portion surrounds the side wall of the inflow region. Here, the first chamber is delimited by a first segment of the side wall, the dividing wall and the bottom wall. The second chamber is delimited by a second segment of the side wall and the dividing wall. The first chamber is therefore of pot-like configuration, while the second chamber is of tubular configuration.

A seal element for preventing a discharge of the second cooling fluid flow which is situated in the cavity via the at least one first outlet opening is preferably arranged between the inner side of the outer wall and an outer side of the side wall in the axial direction below the at least one first outlet opening. For example, that outer side of the side wall which is arranged so as to bear against the inner side of the outer wall can have an annular groove, in which the seal element in the form of a sealing ring is arranged, wherein the sealing ring is arranged below the at least one first outlet opening in the axial flow direction of the cooling fluid. A tight connection can thus be ensured between the component which configures the inflow region and the hollow shaft. Moreover, the arrangement of the sealing ring below the at least one first outlet opening can ensure that the cooling fluid of the second cooling fluid flow which flows into the cavity cannot exit into the surrounding area via the at least one first outlet opening, but rather only via the at least one second outlet opening.

It proves advantageous if the inflow region is arranged on a transmission side of the hollow shaft, and additionally configures a coupling region for coupling to a transmission or a transmission component of the transmission of the motor vehicle. For example, the coupling region can be configured for coupling to a transmission shaft of the transmission. To this end, an inner side of the side wall of the housing can have a spline system which can configure a plug-in connection with an external spline system on the transmission shaft. The coupling region can also have a transmission pinion of the transmission which is configured in one piece with the hollow shaft. A part, projecting out of the cavity, of the side wall of the inflow region can configure, moreover, a radial seat or bearing seat for a bearing of the electric machine.

In one development of the invention, the inner side, facing the cavity, of the outer wall has cooling fins which extend in the circumferential direction and are arranged spaced apart axially from one another. The inner side of the outer wall is therefore of finned configuration in order to increase the cooling performance, wherein the cooling fins are configured, for example, as respective intermediate walls between two annular grooves which are configured in the inner side.

The embodiments presented in relation to the rotor shaft according to the invention and their advantages apply mutatis mutandis to the rotor according to the invention and to the electric machine according to the invention.

Further features of the invention will become apparent from the claims, the figures and the description of the figures. The features and combinations of features mentioned above in the description and the features and combinations of features mentioned below in the description of the figures and/or shown solely in the figures can be used not only in the respective specified combination, but rather also in other combinations or on their own.

The invention will now be explained in greater detail on the basis of one preferred exemplary embodiment and with reference to the drawings.

### BRIEF DESCRIPTION OF THE DRAWINGS

FIG. 1 shows a perspective illustration of a rotor shaft for a rotor of an electric machine,

FIG. 2 shows a longitudinal sectional illustration of an inflow region of the rotor shaft, and

FIG. 3 shows a cross-sectional illustration through the inflow region.

### DETAILED DESCRIPTION OF THE DRAWINGS

Identical and functionally identical elements are provided in the figures with the same designations.

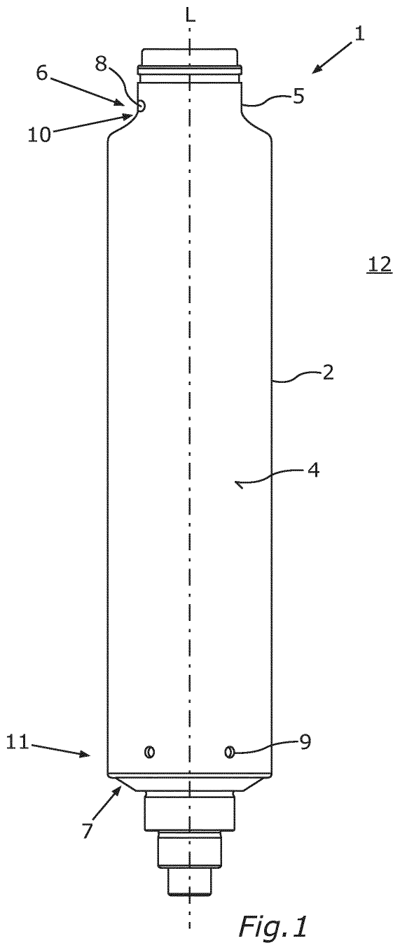

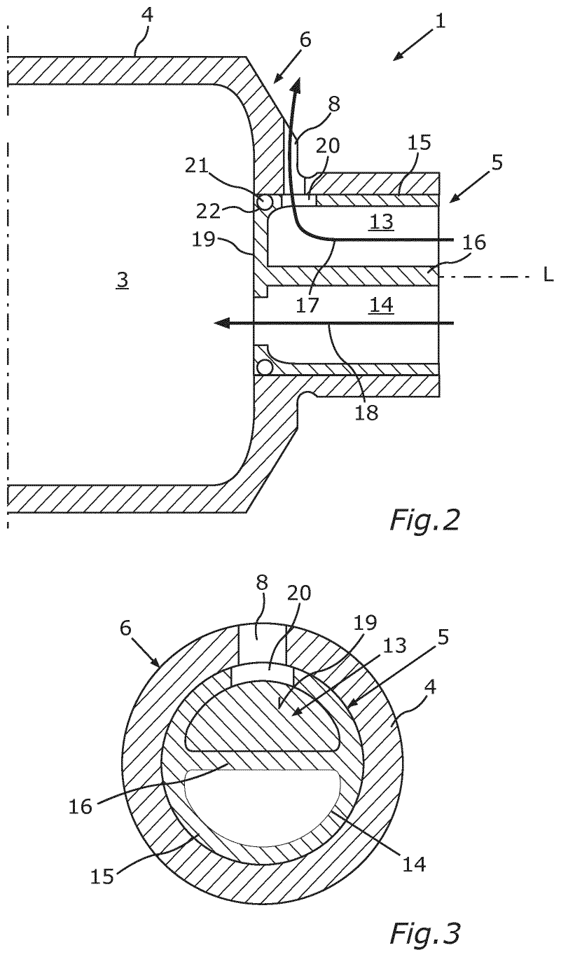

FIG. 1 shows a perspective illustration of a rotor shaft 1 for a rotor of an electric machine of a motor vehicle. An axially extending longitudinal axis L of the rotor shaft 1 corresponds to an axis of rotation of the rotor. The rotor shaft 1 has a hollow shaft 2 which, as is shown using the longitudinal section in FIG. 2, is formed by an outer wall 4 which encloses a cavity 3. A cooling fluid can flow axially through this cavity 3, which cooling fluid is fed to the hollow shaft 2 via an inflow region 5 of the rotor shaft 1. The inflow region 5 is arranged on a first, transmission-side side 6 of the hollow shaft 2. A second side 7, lying opposite the first side 6, of the hollow shaft 2 is of closed configuration.

Here, the cooling fluid which is fed to the hollow shaft 2 is deposited via outlet openings 8, 9 on two axially opposite end portions 10, 11 of the outer wall 4 out of the cavity 3 into a surrounding area 12 of the rotor. In order to adjust the cooling fluid quantity which is distributed to the end portions 10, 11, the inflow region 5 which, as is also shown using the cross-sectional illustration in FIG. 3, is situated in the first end portion 10 of the hollow shaft 2 has two chambers 13, 14. The chambers 13, 14 are delimited in the radial direction and in the circumferential direction by a circumferential side wall 15 of the inflow region 5 and a dividing wall 16. The cooling fluid which flows into the inflow region 5 is therefore split into two cooling fluid flows 17, 18, wherein the first cooling fluid flow 17 flows into the first chamber 13 and the second cooling fluid flow 18 flows into the second chamber 14. The cooling fluid flows 17, 18 run in parallel when flowing in.

The cooling fluid flow 17 which is introduced into the first chamber 13 remains in the first end portion 10 by the first chamber 13 being closed off in the axial direction by a bottom wall 19. This bottom wall 19 forms a baffle wall for the first cooling fluid flow 17 and deflects it in the radial direction. That portion of the side wall 15 which adjoins the first chamber 13 has at least one radial through opening 20 which is arranged aligned with respect to the at least one first outlet opening 8. The first cooling fluid flow 17 therefore exits from the first chamber 13 via the through opening 20 and the at least one first outlet opening 8 on the first side 6 into the surrounding area 12.

The cooling fluid flow 18 which is introduced into the second chamber 14 flows through the bottomless second chamber 14 axially and exits from the second chamber 14 into the cavity 3 of the hollow shaft 2. The second cooling fluid flow 18 flows through the cavity 3 as far as the second side 7, and exits there via the at least one second outlet opening 9 from the cavity 3 into the surrounding area 12. In order to prevent the second cooling fluid flow 18 from being able to also exit via the at least one first outlet opening 8, a seal element 21 in the form of a sealing ring is arranged between the side wall 15 and the outer wall 4 below the at least one first outlet opening 8. This sealing ring is situated, for example, in an annular groove 22 of the side wall 15.

1-9. (canceled)

10. A rotor shaft for a rotor of an electric machine comprising:
a tubular hollow shaft configured to support a rotor core of the rotor and to conduct a cooling fluid in a cavity that is enclosed by an outer wall of the hollow shaft, wherein the outer wall has, in order to discharge the cooling fluid on two axially opposite sides of the rotor shaft into a surrounding area, at least one first radial outlet opening in a first end portion of the outer wall and at least one second radial outlet opening in an axially opposite second end portion of the outer wall; and
an inflow region for the cooling fluid which is arranged in the region of the first end portion in the hollow shaft,
wherein the inflow region is divided by at least one axially extending dividing wall into at least two chambers configured to split the cooling fluid into at least two parallel cooling fluid flows,
wherein a first chamber is closed axially by a bottom wall that forms an axial baffle wall for the first cooling fluid flow and is coupled fluidically to the at least one first outlet opening for the radial discharge of the first cooling fluid flow on a first side of the rotor shaft, and
wherein a second chamber is configured without a bottom in order to introduce the second cooling fluid flow into the cavity, and is coupled fluidically to the at least one second outlet opening for the radial discharge of the second cooling fluid flow on a second side of the rotor shaft.

11. The rotor shaft according to claim 10,
wherein the at least one dividing wall is arranged centrally in the inflow region and divides the inflow region into two chambers of identical size.

12. The rotor shaft according to claim 10,
wherein the inflow region has a side wall that runs around in a circumferential direction, is connected to the at least one dividing wall, is arranged so as to bear against an inner side of the outer wall, and has, in a region of the first chamber, at least one radial through opening for the first cooling fluid flow that is arranged aligned with respect to the at least one first outlet opening.

13. The rotor shaft according to claim 12,
a seal element configured to prevent a discharge of the second cooling fluid flow which is situated in the cavity via the at least one first outlet opening, wherein the seal element is arranged between the inner side of the outer wall and an outer side of the side wall in an axial direction below the at least one first outlet opening.

14. The rotor shaft according to claim 12,
wherein the inflow region is arranged on a transmission side of the hollow shaft, and additionally configures a coupling region for coupling to a transmission of a motor vehicle.

15. The rotor shaft according to claim 10,
wherein the hollow shaft is tapered in a region of the first end portion, and
wherein the inflow region extends only over the tapered region of the hollow shaft.

16. The rotor shaft according to claim 10,
wherein an inner side, facing the cavity, of the outer wall has cooling fins that extend in a circumferential direction and are arranged spaced apart axially from one another.

17. A rotor for an electric machine comprising:
a rotor core;
a magnetic field-generating component that is held by the rotor core; and
the rotor shaft according to claim 10.

18. An electric machine for a motor vehicle comprising:
a stator; and
the rotor according to claim 17 that is mounted rotatably with regard to the stator.
